(19) United States
(12) Patent Application Publication
(10) Pub. No.: US 2006/0290227 A1
(43) Pub. Date: Dec. 28, 2006

(54) Circular coil accessory coiling stand

(75) Inventor: Albert Cho, Taipei (TW)

Correspondence Address: BIRCH STEWART KOLASCH & BIRCH, PO BOX 747, FALLS CHURCH, VA, 22040-0747, US

(73) Assignee: Jui-Kai Tseng

(21) Appl. No.: 11/143,639

(22) Filed: Jun. 3, 2005

(51) Int. Cl. H02K 3/00

(52) U.S. Cl. 310/194; 242/434

(57) ABSTRACT

A circular coil accessory coiling stand includes two insulating covers and a wire end stator designed as independent components. The wire end stator is detachably installed onto an external surface of the insulating cover, so that the wire end stator can serve as a fixture for the starting wire of the coil and a basis of jumping wire for the automatic coiling during a coiling process. If the height of the coiled wire is smaller than that of the wire end stator after the coiling operation is completed, the wire end stator can be removed from the insulating cover to overcome the drawback of wasting time on cutting the wire end stator exposed from the coiled wire, if the height of the coiled wire is smaller than the height of the wire end stator, and prevent a wrong cutting of the coiled wire or a scratch of the coiled wire.

### FIELD OF THE INVENTION

The present invention relates to a circular coil accessory coiling stand, and more particularly to a circular coil accessory coiling stand that comes with a design of detachable initial coil stator and insulating cover.

### BACKGROUND OF THE INVENTION

In the traditional electric structure having a circular coil such as a transformer or an inductor, the number of coils usually reaches tens of thousands. Before an automatic coiling machine is introduced to the market, the coiling operation generally takes up the labor of approximately one man-day to finish a piece of products, and thus seriously affecting the production efficiency and limiting the related industry from advancing. The situation is improved a little until the first automatic coiling machine is introduced. It is necessary to wrap a layer of insulating material on an enamel wire for the circular coil is a necessary, and the plastic tape was used for the wrapping at an early stage, and an insulating cover capable of being produced in a mass production is now used instead. This kind of insulating cover includes two symmetrical circular objects capable of wrapping a circular core. However, it is found in practical application that the wire end of the coil is not positioned by drawing the wire, and the following stacked wires will be covered on part of the wire at the wire end, and thus resulting a repetition and a shift at a multiple of points and causing the occurrence of a short circuit or accident and affecting the life of the coil.

In view of the foregoing shortcomings, the inventor of the present invention previously disclosed a “Circular coil accessory coiler” as described in the R.O.C. Patent Publication No. 213760, which comprises a wire stator protruded outwardly and integrally coupled with an insulating cover along the direction parallel to a circular core. The wire stator serves as a positioning device of the coil wire end and a basis of jumping wire for the automatic coiling machine, so that the coil wire end can be fixed precisely onto a certain specific point on the coil after the coil wire end is fixed to the wire stator. As a result, the following coiling operation will not shifted from a fixed point, and thus facilitating the improvement of the quality and stability of the coil. Further, when the coiling machine has coiled a round and returns to the position of the original wire end, the ridge of the wire stator can lead the enamel wire to slide across the wire end, and thus the invention can overcome the shortcoming of the coiling wire repeatedly covering the wire end and requiring to turn the machine on and off, so as to save the labor of manually guiding the crossed wire.

However, the foregoing design still has some drawbacks on its application. Equal height is designed for the wire stator on the insulating cover to facilitate a large quantity of shipment, but different heights are designed for the coils wrapped around the insulating cover to meet the requirements of different products. In an ideal situation, the height of the wire stator is usually equal to the height of the coiled wire. If the coiled wire is shorter than the wire stator, the wire stator exposed from the coiled wire is usually cut manually, so that the coiled wire is cut even with the wire stator. The cutting process not only takes up lots of working hours, but also easily causes a wrong cutting of the coil wire or a scratch of enamel, and further affecting the electric properties of the product.

### SUMMARY OF THE INVENTION

The primary objective of the present invention is to provide a circular coil accessory coiling stand capable of selectively removing a wire end stator from an insulating cover according the result of comparing the height of the coiled wire and the height of the wire end stator, after the coiling operation is completed. The invention can prevent the wrong cutting of the coiled wire or the scratch of paint, if the height of the coiled wire is smaller than the height of the wire end stator, and it is necessary to cut away the wire end stator exposed from the coiled wire.

To achieve the foregoing objective, a circular coil accessory coiling stand in accordance with the present invention comprises two insulating covers for covering a circular core and a wire end stator. The insulating covers and the wire end stator are designed as independent components, and the detachable wire end stator is installed on the external surface of an insulating cover, and the wire end stator can be removed selectively from the insulating cover.

The technical contents of the present invention will now be described in more detail hereinafter with reference to the accompanying drawings that show various embodiments of the invention, in which:

### BRIEF DESCRIPTION OF THE DRAWINGS

FIG. 1 is an exploded view of a circular coil accessory coiling stand according to the present invention;

FIG. 2 is a perspective view of a circular coil accessory coiling stand according to the present invention;

FIGS. 3A to 3C are schematic views of a coiling process for a circular coil accessory coiling stand according to the present invention; and

FIGS. 4 to 8 are lateral cross-sectional views of a circular coil accessory coiling stand according to different preferred embodiment of the present invention.

### DETAILED DESCRIPTION OF THE PREFERRED EMBODIMENTS

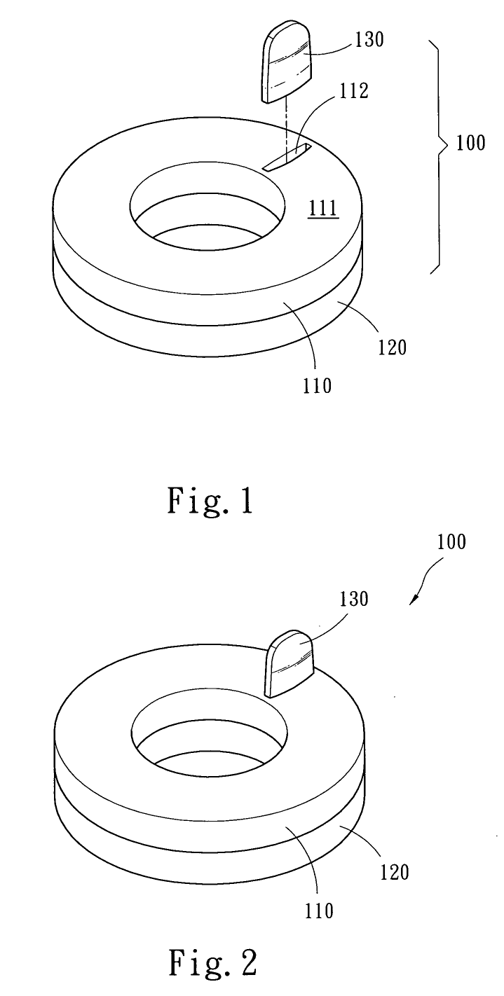

Referring to FIGS. 1 and 2 for the present invention, a circular coil accessory stand 100 comprises two insulating cover 110, 120 and a wire end stator 130. The two insulating covers 110, 120 are provided for covering a circular core (not shown in the figure) to provide an insulating effect between the core and an enameled wire 10 (referring to following drawings). The wire end stator 130 and the two insulating covers 110, 120 are designed as independent components during the manufacturing, and the wire end stator 130 is detachably installed onto an external surface 111 of the insulating cover 110. The shapes of wire end stator 130 include but not limited to a sheet, a cylindrical, a conical, or a bar shape.

To achieve the installation of the foregoing detachable wire end stator 130 onto the external surface 111 of the insulating cover 110 according to this embodiment, an embedded groove 112 is created on the external surface 111 of the insulating cover 110 for embedding the bottom of the wire end stator 130.

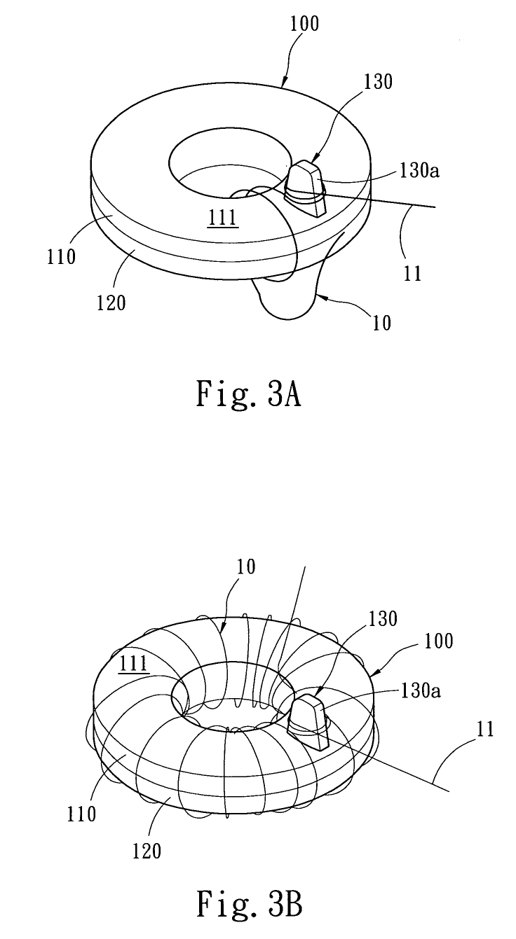

Referring to FIGS. 3A to FIG. 3C, after the wire end stator 130 is installed onto the external surface 111 of the insulating cover 110, the coiling operation can be started. Firstly, the end of the wire is drawn by an automatic coiling machine (not shown in the figure), and after the wire is coiled upward from the lower section of the circular coil accessory coiling stand 100 as shown in FIG. 3A, the extra wire is fixed onto the wire end stator 130 to produce a section of wire end 11. By that time, the wire end 11 is fixed, and then the automatic coiling machine is turned on to wrap the enameled wire 10 onto the two insulating covers 110, 120 until the enameled wire 10 is wrapped for a complete round (as shown in FIG. 3B). When following enameled wire 10 is drawn from the automatic coiling machine, and the circular coil accessory coiling stand 100 is rotated slightly with a small angle, the enameled wire 10 will slide across the ridge 130a of the wire end stator 130 and fall to another side of the wire end stator 130 as shown in FIG. 3C. Therefore, the wire end stator 130 of the invention also can act as the fixture for the coil end and the basis of jumping wire for the automatic coiling so as to maintain the advantages of the product.

It is noteworthy that after the coiling operation is completed, the wire end stator 130 can be selectively removed from the insulating cover 110, if the height of the coiled wire is smaller than the height of the wire end stator 130. In other words, if the height of the coiled wire is smaller than the height of the wire end stator 130, the wire end stator 130 can be removed from the insulating cover 110 according to the requirements or properties of the product (such as a transformer or an inductor), so at to prevent the drawback of wasting working hours on cutting the wire end stator 130 exposed from the coiled wire if the height of the coiled wire is smaller than the height of the wire end stator 130. Such arrangement according to the prior art may cut the coiled wire by accident or scratch the enamel of the coiled wire, and further may affect the electric properties of the product. If the height of the coiled wire is equal to the height of the wire end stator 130, then the step of removing the wire end stator 130 can be omitted.

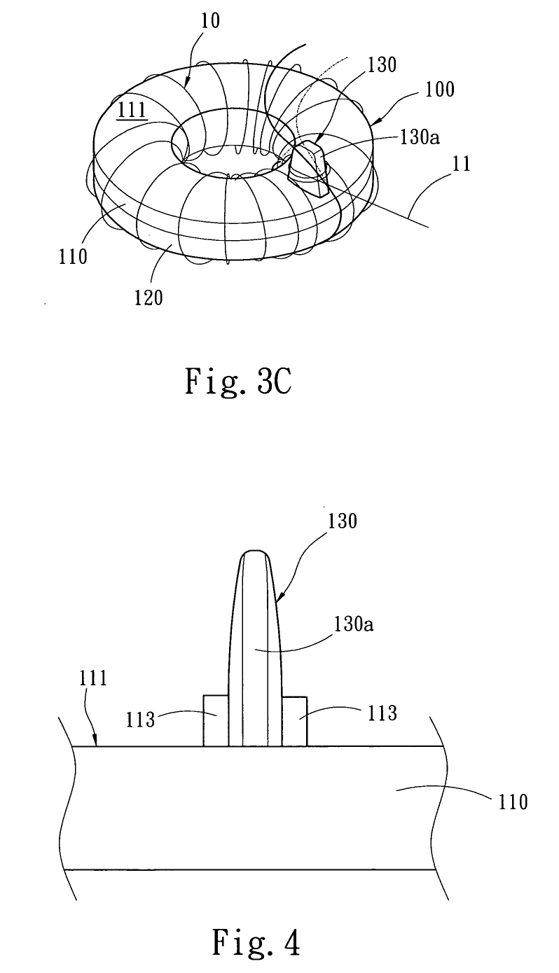

However, the foregoing design of detachably installing the wire end stator 130 onto the external surface 111 of the insulating cover 110 is not limited to the above embodiment, but it can be achieved by other implementations. Referring to FIG. 4, at least a pair of parallel ribs 113 is protruded from the external surface 111 of the insulating cover 110, and an embedded space is defined between the pair of ribs 113 for embedding and fixing the bottom of the wire end stator 130.

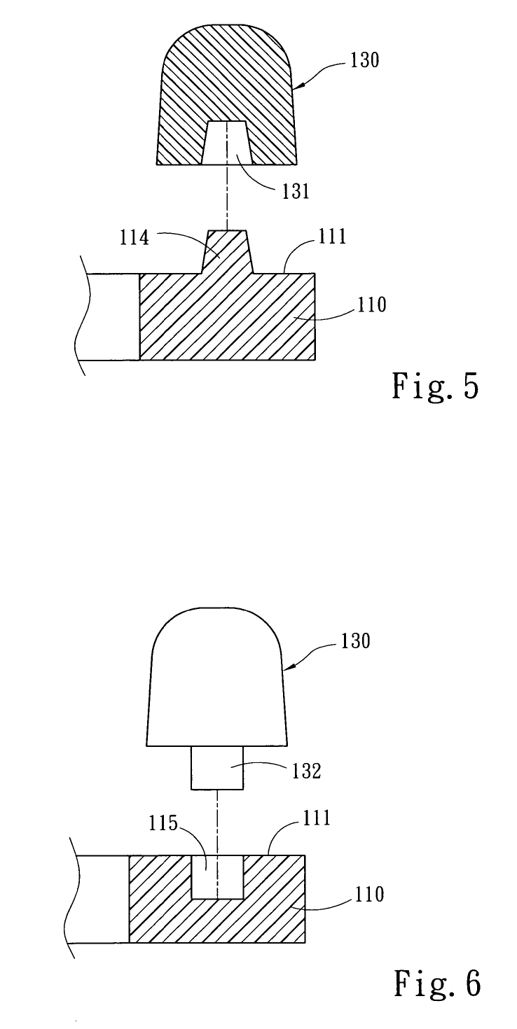

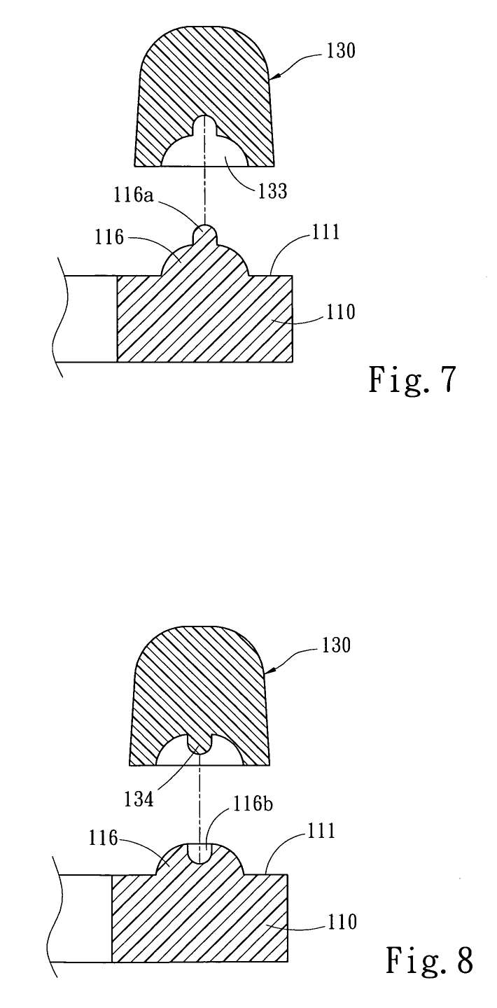

Of course, those skilled in the arts should know that several pairs of ribs 113 can be installed to fit the appearance of the bottom of the wire end stator 130, and mechanically interfere with the wire end stator 130. Referring to FIG. 5, a protrusion 114 is protruded from the external surface 111 of the insulating cover 110, and an embedded groove 131 corresponding to the appearance of the protrusion 114 is disposed at the bottom of the wire end stator 130 for embedding and fixing the protrusion 114 on the insulating cover 110. Of course, a protrusion 132 can be protruded from the bottom of the wire end stator 130 as shown in FIG. 6, and an embedded groove 115 corresponding to the appearance of the protrusion 132 is disposed on the external surface 111 of the insulating cover 110 for embedding and fixing the protrusion 132 at the bottom of the wire end stator 130. Further, an embedded base 116 is disposed on the external surface 111 of the insulating cover 110 as shown in FIG. 7, and a protrusion 116a is protruded from the embedded base 116, and an embedded groove 133 corresponding to the appearance of the protrusion 116a at the bottom of the wire end stator 130 for embedding and fixing the protrusion 11 6a of the embedded base 116. Further, a protrusion 134 is protruded from the bottom of the wire end stator 130 as shown in FIG. 8, and an embedded base 116 is disposed on the external surface 111 of the insulating cover 110, and an embedded groove 116b is disposed on the embedded base 116 for embedding and fixing the protrusion 134 at the bottom of the wire end stator 130.

In summation of the description above, the circular coil accessory coiling stand of the present invention uses the design of the detachable wire end stator and the insulating cover, not only serving as a fixture for the wire end and a basis of jumping wire for automatic coiling and maintaining the existing advantages, but also removing the wire end stator from the insulating cover after the coiling operation is completed and when the height of the coiled wire is smaller than the height of the wire end stator. Thus, the present invention can save the working hours and prevent the coiled wire from being cut incorrectly or the enamel of the coiled wire from being scratched, if the height of the coiled wire is smaller than the height of the wire end stator, and it is necessary to cut away the coiled wire exposed from the wire end stator.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A circular coil accessory coiling stand, comprising two insulating covers for covering a circular core, and a wire end stator, characterized in that said insulating covers and said wire end stator are independent components, and said wire end stator is detachably installed on an external surface of one of said insulating covers.

2. The circular coil accessory coiling stand of claim 1, wherein said insulating cover includes an embedded groove disposed on said external surface for embedding the bottom of said wire end stator.

3. The circular coil accessory coiling stand of claim 1, wherein said insulating cover includes at least one pair of parallel ribs disposed on said external surface, and an embedding space is defined between said pair of ribs for embedding the bottom of said wire end stator.

4. The circular coil accessory coiling stand of claim 1, wherein said insulating cover includes a protrusion disposed on said external surface, and said wire end stator includes an embedded groove disposed on the bottom and corresponding to the appearance of said protrusion for embedding said protrusion on said insulating cover.

5. The circular coil accessory coiling stand of claim 1, wherein said wire end stator includes a protrusion at its bottom, and said insulating cover includes an embedded groove disposed on said external surface and corresponding to the appearance of said protrusion for embedding said protrusion at the bottom of said wire end stator.

6. The circular coil accessory coiling stand of claim 1, wherein said insulating cover includes an embedded base disposed on said external surface, and said embedded base includes a protrusion, and said wire end stator at its bottom includes an embedded groove corresponding to the appearance of said protrusion for embedding said protrusion of said embedded base.

7. The circular coil accessory coiling stand of claim 1, wherein said wire end stator at its bottom includes a protrusion, and said insulating cover includes said embedded base disposed on said external surface, and said embedded base includes an embedded groove for embedding said protrusion disposed at the bottom of said wire end stator.
